(19) United States
(12) Patent Application Publication
(10) Pub. No.: US 2018/0101934 A1
(43) Pub. Date: Apr. 12, 2018

(54) DEVICE AND A METHOD FOR CREATING AN IMAGE

(71) Applicant: Macau University of Science and Technology, Taipa (MO)

(72) Inventors: Zhanchuan Cai, Taipa (MO); Ben Ye, Taipa (MO)

(21) Appl. No.: 15/286,997

(22) Filed: Oct. 6, 2016

(51) Int. Cl. G06T 3/40; G06T 7/00; G06T 3/00

(52) U.S. Cl. CPC G06T 3/4038; G06T 7/0042; G06T 2200/32; G06T 7/0097; G06T 3/0068

(57) ABSTRACT

A method for creating an image includes identifying data representing an overlapping region in each of a first set and second set of image data, wherein the first and second sets of image data are arranged to represent a first image and a second image respectively, and at least one common feature in both the first image and the second image is identified in the overlapping region. A portion of the data representing a portion of the overlapping region in each of the first and the second sets of image data is discarded to obtain a first set and a second set of modified image data. The first and the second sets of modified image data are combined to a third set of image data arranged to represent a third image including at least a portion of each of the first image and the second image.

### TECHNICAL FIELD

The present invention relates to a device and a method for creating an image, and particularly, although not exclusively, to a device and a method for creating a panoramic image.

### BACKGROUND

An image may represent an object or a scene which may be virtual or real in nature. In some applications, images may be created by transforming recorded image data to a printing or light signal with different colors and light intensities. The image data may be recorded using a camera or an imaging device which may record the colors and light of the original objects or scene.

Due to a limitation in optics and camera sensor, viewing angles of a camera are usually restricted to a predetermined range. In some occasion, the camera may not be able to capture a desire image which may cover a view angle being larger than the designed range.

### SUMMARY OF THE INVENTION

In accordance with a first aspect of the present invention, there is provided a method for creating an image, comprising the steps of identifying data representing an overlapping region in each of a first and a second sets of image data, wherein the first and the second sets of image data are arranged to represent a first image and a second image respectively, and at least one common feature in both the first image and the second image is identified in the overlapping region; discarding a portion of the data representing a portion of the overlapping region in each of the first and the second sets of image data to obtain a first and a second sets of modified image data; and combining the first and the second sets of modified image data to a third set of image data arranged to represent a third image including at least a portion of each of the first image and the second image.

In an embodiment of the first aspect, a portion of the data representing a portion of the overlapping region is defined by a divider within the overlapping region and at least one boundary of the overlapping region.

In an embodiment of the first aspect, the divider is defined at or proximate to a center position between the boundaries of the overlapping region.

In an embodiment of the first aspect, the method further comprises the step of transforming the divider into a linear line using interpolation.

In an embodiment of the first aspect, the method further comprises the step of performing a regression analysis on a plurality of feature points associated with the at least one common feature to define the divider.

In an embodiment of the first aspect, the regression analysis include a least square analysis.

In an embodiment of the first aspect, the method further comprises the step of comparing the first and the second sets of image data so as to determine the plurality of feature points.

In an embodiment of the first aspect, the method further comprises the step of discarding at least one of the plurality of feature points based on at least one selection criteria.

In an embodiment of the first aspect, the at least one selection criteria includes at least one of: a position of the feature point beyond a predetermined region in the first and/or the second image; and a position of the feature point beyond the overlapping region in the first and/or the second sets of image data.

In an embodiment of the first aspect, the third image is a panoramic image.

In accordance with a second aspect of the present invention, there is provided a device for creating an image, comprising a data processing module arranged to identify data representing an overlapping region in each of a first and a second sets of image data, wherein the first and the second sets of image data are arranged to represent a first image and a second image respectively, and at least one common feature in both the first image and the second image is identified in the overlapping region; and an image processing module arranged to discard a portion of the data representing a portion of the overlapping region in each of the first and the second sets of image data to obtain a first and a second sets of modified image data, and arranged to combine the first and the second sets of modified image data to a third set of image data arranged to represent a third image including at least a portion of each of the first image and the second image.

In an embodiment of the second aspect, a portion of the data representing a portion of the overlapping region is defined by a divider within the overlapping region and at least one boundary of the overlapping region.

In an embodiment of the second aspect, the divider is defined at or proximate to a center position between the boundaries of the overlapping region.

In an embodiment of the second aspect, the data processing module is further arranged to transform the divider into a linear line using interpolation.

In an embodiment of the second aspect, the data processing module is further arranged to perform a regression analysis on a plurality of feature points associated with the at least one common feature to define the divider.

In an embodiment of the second aspect, the regression analysis include a least square analysis.

In an embodiment of the second aspect, the data processing module is further arranged to compare the first and the second sets of image data so as to determine the plurality of feature points.

In an embodiment of the second aspect, the data processing module is further arranged to discard at least one of the plurality of feature points based on at least one selection criteria.

In an embodiment of the second aspect, the at least one selection criteria includes at least one of a position of the feature point beyond a predetermined region in the first and/or the second image; and a position of the feature point beyond the overlapping region in the first and/or the second sets of image data.

In an embodiment of the second aspect, the third image is a panoramic image.

### BRIEF DESCRIPTION OF THE DRAWINGS

Embodiments of the present invention will now be described, by way of example, with reference to the accompanying drawings in which:

FIG. 1A is an image showing a lunar surface and a exploration route of a moon rover;

FIG. 1B is an image showing the moon rover landed on a moon surface, wherein a panoramic camera is mounted on the moon rover for capturing images of the lunar surface;

FIGS. 2A and 2B are illustrations showing examples of different shooting view angles and ranges of the left and right cameras of the panoramic camera mounted on the moon rover;

FIGS. 3A and 3B are illustrations showing a Gaussian pyramid model of SIFT and SURF respectively;

FIG. 4 is a block diagram of a device for generating an image in accordance with an embodiment of the present invention;

FIG. 5 is an illustration showing the left and right camera capturing a same object with in different angles;

FIG. 6 is a flow diagram showing a method for generating an image in accordance with an embodiment of the present invention;

FIG. 7 is an illustration showing four possible arrangements of two original images being combined;

FIG. 8 is an illustration showing a divider line, a useful area and a useless are defined by the LLF process of FIG. 6;

FIG. 9 is an illustration showing two pixels being processed by interpolation;

FIG. 10 are two source images to be stitched;

FIG. 11 is a combined image of the two source images of FIG. 10, wherein the same features are marked in circles and the matching points are marked by lines between the circles;

FIG. 12 are plots showing the matching features and the divider lines determined based on the matching features on the two source images of FIG. 10;

FIG. 13 are the two source images being modified with a portion of the overlapping region of each image being discarded and represented in black color;

FIG. 14 is a result panoramic image of the source images of FIG. 10 processed by the method in accordance with the present invention;

20

FIGS. 15A, 15B, 15C, 15D, 15E and FIGS. 16A, 16B, 16C, 16D, 16E are source and result images and plots of two another stitching examples which are similar to the example of FIGS. 10 to 14;

FIG. 17 is a panoramic image of a lunar surface generated by the method in accordance with the present invention;

FIG. 18 is an illustration of a source image being divided into multiples portions;

FIG. 19A shows two source images to be stitched;

FIGS. 19B, 19C, 19D, and 19E are combined panoramic images of the source images of FIG. 19A obtained using linear least square method, B-splines least square method, Many knot splines least square method, and the method in accordance with the present invention, respectively;

FIG. 20A shows two source images to be stitched;

FIGS. 20B, 20C, 20D, and 20E are combined panoramic images of the source images of FIG. 20A obtained using linear least square method, B-splines least square method, Many knot splines least square method, and the method in accordance with the present invention, respectively; and

FIG. 21A shows two source images to be stitched;

FIGS. 21B, 21C, 21D, and 21E are combined panoramic images of the source images of FIG. 21A obtained using linear least square method, B-splines least square method, Many knot splines least square method, and the method in accordance with the present invention, respectively.

### DETAILED DESCRIPTION OF THE PREFERRED EMBODIMENT

The inventors have, through their own research, trials and experiments, devised that image stitching may be used in generation of panoramic image and application. For example, seamless image stitching which minimize false edges may be applied. Alternatively, stitching images may involve minimal solutions for the geometric parameters of a camera rotating about its optical center.

In some other examples, automatic stitching method such as SIFT may be used. SIFT may be further improved with a structure deformation method on processing stitching mission. Alternatively, a stitching method utilizing SIFT and mean seamless cloning technique may be applied.

The stitching method may be used in processing cell phone and camera panoramic image. However, some of these methods may not keep the original information obtained, and thus may not be suitable for applications involving space environment problems.

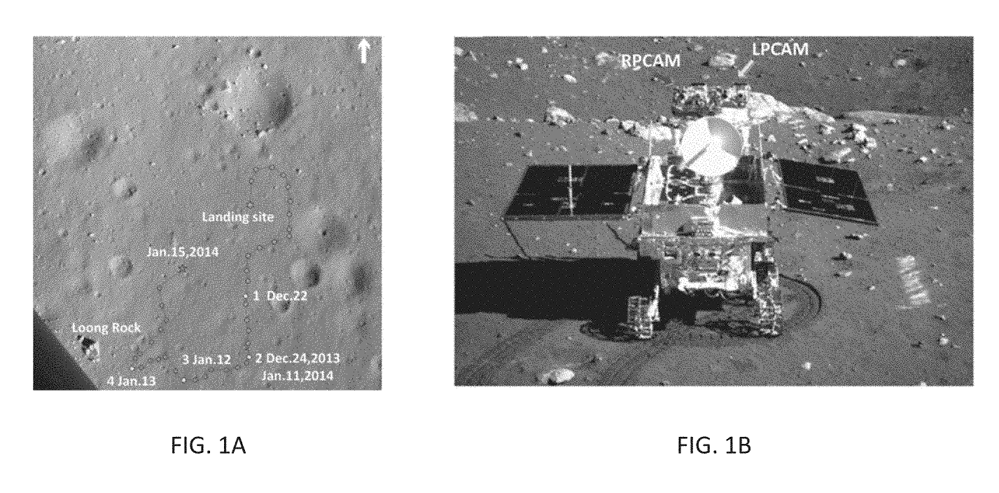

With reference to FIG. 1A, on the moon's surface, there exist surface features such as craters, mountain ranges, rilles, and lava plains. Image of these features may be useful in studying these features. To enhance the image quality, methods such as image fusion, image correction and image registration may be used. Other methods such as combining DEM data, radar data and multi-spectral image may be used to obtain clear lunar surface images which may help studying lunar history and geological.

In an illustrative example, the panoramic camera, one of the precision instruments on a lunar rover called “Yutu rover”, which is used to obtain images of the moon's surface in a lunar surface exploration mission—the Chang' E-3 mission. Stitching panoramic images may be used to provide useful information of the moon for better understanding of the environmental conditions around the landing site.

Preferably, a continuous image of the lunar surface will help observing the lunar surface, which allows studying of lunar dust, crater and stone. In addition, it is also helpful for designing a lunar rover having ability to navigate and avoid obstacle automatically in an unknown environment.

The panoramic camera (PCAM) is one of the rover's major scientific payloads, with two cameras installed on the mast of the Yutu rover, it has ability to take colorized and panchromatic image data. The main performances of PCAM are as shown in Table 1. The processed data is sampled and returned by Chang' E-3 rover Yutu, and it contains head data and record data. Head data, which describes the rules of data distribution and sample attitude (see Table 2). According to head data, that recorded data array is based on a constant order as R-G-B. The length of colorized image data is 12192768 (2352×1728×3). To processing the image data, the first stage is separate layer.

Tᵢ =(i+Lₕ) mod3, where i=1, 2, 3, . . . , 12192768, Ti is a judgement variate, which can decide record i's layer. Lₕ represents the length of head data, and i+Lₕ is location about record i in PCAM data.

$$\{ \begin{matrix}{c}_{r} ← {A}_{i + {L}_{h}} & {T}_{i} = 1 \\ {c}_{y} ← {A}_{i + {L}_{h}} & {T}_{i} = 2 \\ {c}_{b} ← {A}_{i + {L}_{h}} & {T}_{i} = 0\end{matrix} \qquad ( 1 )$$

If Tᵢ is equal to 1, this record data locate in red layer, and if Tᵢ equal to 2 or 3 the data locate in green or blue layer. Then the record distinguished into R-G-B arrays, transform this 3 array into 3 matrixes as 2352×1728, and the lunar surface high definition (HD) image have been obtained by compound this 3 matrixes at last.

TABLE I
PERFORMANCE OF PCAM

| | |
|---|---|
| Wave band | Visible light |
| Color | R-G-B |
| ScanAsyst | colorized and panchromatic |
| Normal imaging distance | 3~∞ |
| Number of Effective pixels | 2352 × 1728 (colorized), |
| | 1176 × 864 (panchromatic) |
| Field angle | 19.7° × 14.5° |
| Quantized value | 10 |
| S/N (dB) | ≥40 (maximum S/N), ≥30 |
| | (albedo 0.09, solar altitude 30°) |
| System static transfer function (MTF) | ≥0.20 (Full Field) |

TABLE II
THE FORMATION OF HEAD DATA

| | |
|---|---|
| PDS_VERSION_ID | PDS3 |
| PDS_VERSION_ID | PDS3 |
| RECORD_TYPE | FIXED_LENGTH |
| RECORD_BYTES | 2352 |
| FILE_RECORDS | 5187 |
| LABEL_RECORDS | 3 |
| IMAGE | 4 |
| DESCRIPTION | “PCAM 2C description.pdf” |
| PRODUCT_NAME | “PCAM Science Data Product” |
| PRODUCT_LEVEL | 2C |
| . | . |
| . | . |
| . | . |

With reference to FIG. 1B, there are two high definition panoramic cameras installed on the Yutu rover, such as an LPCAM and an RPCAM. The record data are reconstructed into an image. To get a better stitching result, capture rules and location environment are important information. With reference to FIG. 1A, the lunar daytime stops of the lunar rover are recorded as the spots shown along the path. The rover captured lunar surface images at four places on 22 Dec. 2013, 24 Dec. 2013, 12 Jan. 2014 and 13 Jan. 2014 respectively.

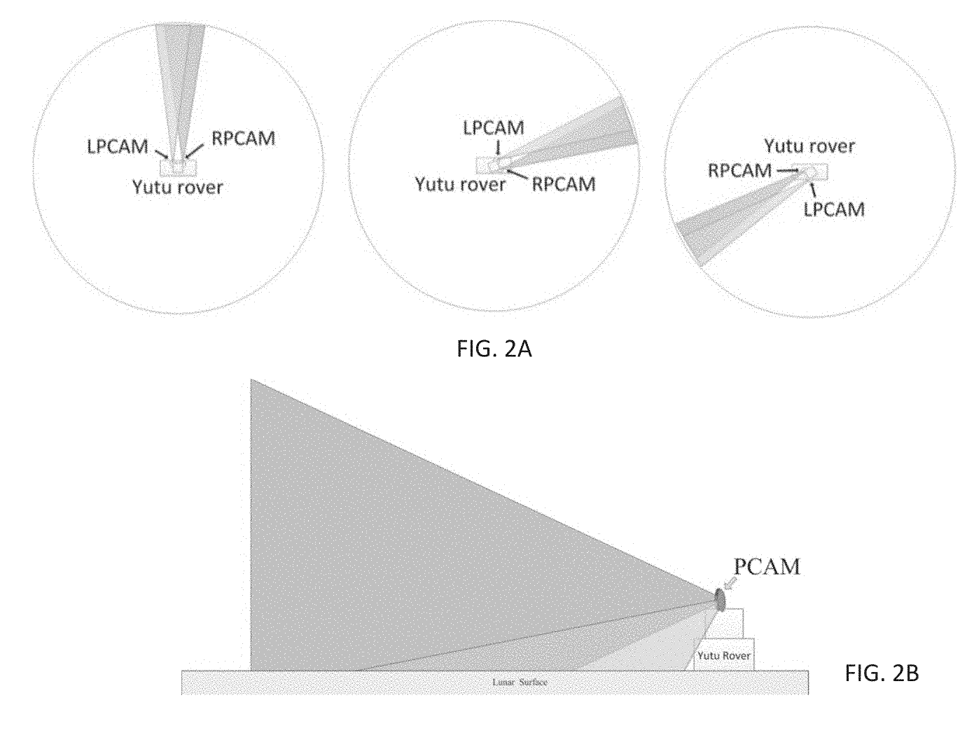

In order to get panoramic images, the camera(s) may be arranged to change the capture angle for shooting different pictures. With reference to FIG. 2A, the camera(s) may be arranged to capture image with different shooting angles. The two shaded regions represent the sampling region of Left panoramic camera (LPCAM) and Right panoramic camera (RPCAM). The camera may rotate roughly θ (θ≈14.5°) between borders upon sampling data.

Besides capturing horizontal images, the PCAM may rotate with an elevation angle about −36° to get close quarter pictures. With reference to FIG. 2B, the left and right cameras may be arranged in different camera attitude, wherein the shared regions represent cameras' vision about different elevation angle, i.e. 0° and −36°. In this example, the Yutu rover in total returns 112 panoramic image data at a sampling location.

Without wishing to be bound by theory, stitching method which consults format of image and image's conceal information may reduce mistake or error. In accordance with an embodiment of the present invention, there is provided a method of stitching or generating of images, which involves least-loss filling (LLF). The features decide stitching direction and position, it will affect stitching quality, so finding an appropriate feature operator may be an important stage for this method. Gaussian kernel may be applied to generate scale space, considering the speed and effect of the Speeded Up Robustness Feature (SURF), it may be used as a core operator on LLF.

Preferably, SIFT and/or SURF may be applied in a stitching process for panoramic image, which provides advantages such as distinctiveness, great-quantity, high-speed and extendibility. Furthermore, these two methods may partly solve problems such as projective transformation, illumination, occlusion, and scene with clutter and noise, therefore may suit with the problem in PCAM images.

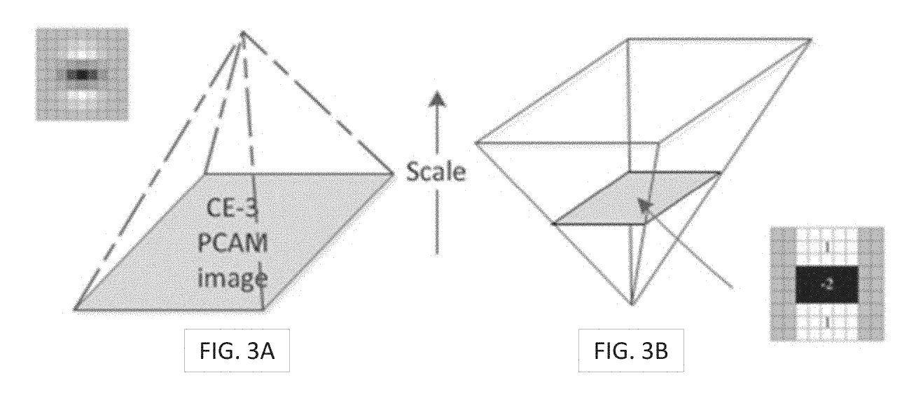

With reference to FIGS. 3A and 3B, SURF involves different method on construction scale space structure for Gaussian pyramid, which selects the main direction of feature points and builds the feature point descriptors, which may enable the method to be perform faster in computing and comparing. SIFT and SURF may be divided into four stages:

Stage 1 Scale-space extreme detection

Stage 2 Key point localization

Stage 3 Orientation assignment

Stage 4 Feature point descriptor

In the step of Scale-space extreme detection, SIFT's Gaussian template is unchanged, it only changes the size of image in the different octave. In SURF, the size of image is unchanged, it obtains detected image by using metabolic size with Gaussian Blur template.

Referring to FIG. 3A, there is shown the pyramid construction with SIFT. In this method, size of layer image is changed and it uses Gaussian function to filtering sublayer over and over again. In contrast, referring to FIG. 3B, the original image is unchanged, however the size of filter matrix is changed. SURF uses this mode to reduce processing steps with subsampling, so that it may improve the processing speed.

SURF and SIFT use the same method step of key point localization, but use different ways on orientation assignment. SIFT specified each keypoint direction parameters and makes operator with rotation invariance by utilizing neighborhood pixel's gradient direction and keypoint's distribution characteristics.

To generate orientation histogram, a revolution of 360 degrees is divided into 36 intervals, and then the heights of each interval are determined. Peak hm district is defined to be the main direction. To enhance the robustness, any other's height may be considered as the auxiliary direction of keypoint, which is above 0.8×hm. Then each of the keypoints may include three tags: location, scale and direction. In the final step of SIFT, it has 4×4×8=128 dimension vectors to describe a feature.

For SURF, dimension vector may be decreased to 64. In the stage of matching feature points, SURF has fewer vectors to compare, that may reduce computing time. With reference to Table 3 below, processing time/scale/changes/rotation/blur/illumination/affine are compared. In one example embodiment, considering the scale-invariant, illumination and computing time, SUFT may be applied as a main feature operator in least loss filling.

TABLE III
COMPARE SIFT WITH SURF

| meth- | | | Rota- | | Illumi- | Af- |
|---|---|---|---|---|---|---|
| od | Time | Scale | tion | Blur | nation | fine |
| Sift | common | best | best | common | common | good |
| Surf | best | common | common | good | best | good |

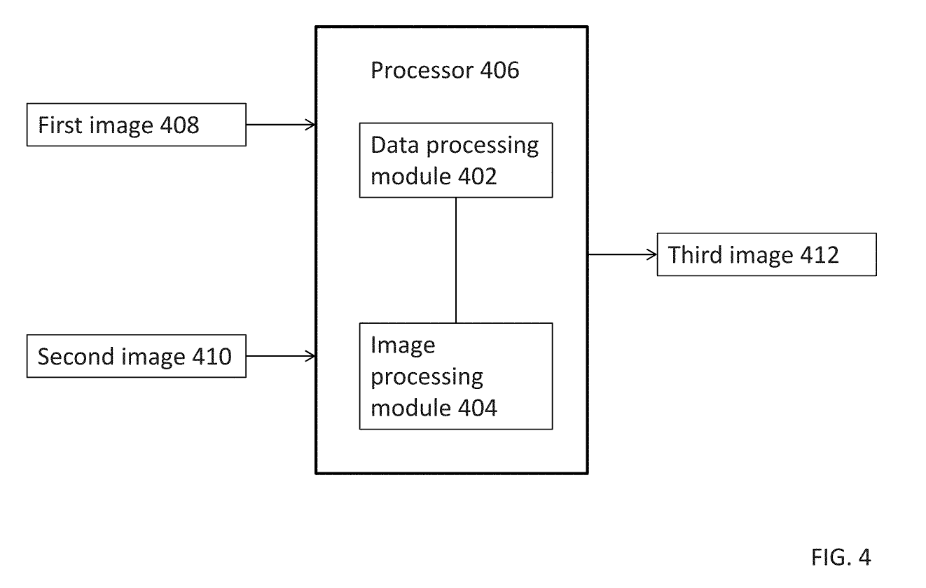

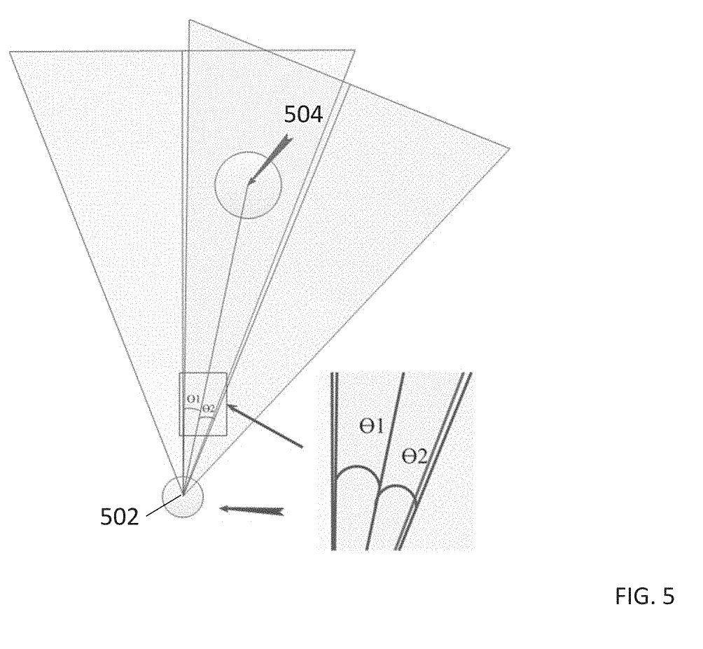

With reference to FIG. 4, there is provided an embodiment of a device 400 for creating an image, comprising a data processing module 402 arranged to identify data representing an overlapping region in each of a first and a second sets of image data, wherein the first and the second sets of image data are arranged to represent a first image and a second image 410 respectively, and at least one common feature in both the first image 408 and the second image 410 is identified in the overlapping region; and an image processing module 404 arranged to discard a portion of the data representing a portion of the overlapping region in each of the first and the second sets of image data to obtain a first and a second sets of modified image data, and arranged to combine the first and the second sets of modified image data to a third set of image data arranged to represent a third image 412 including at least a portion of each of the first image 408 and the second image 410.

In this embodiment, the data processing module 402 and/or the image processing module 404 may be implemented as components of a camera, such as an image processor 406 integrated in a camera for processing the image captured by the camera. Alternatively, the data processing module 402 and the image processing module 404 may be individually implemented in separate processor 406, or may be implemented in a processing unit 406 or a computer arranged to process images imported from external sources.

In some examples of image capturing, image data may be recorded as light intensities of different colours sensed at different positions by the camera sensor. With different sets of image data, through image processing, images may be “restored” to represent the objects/scene being captured or recorded by the camera. By analysing and modifying the recorded image data, the image may be modified accordingly.

Preferably, a first image 408 and a second image 410 corresponding to the source images may be processed by the data processing module 402 and the image processing module 404, so as to generate a third image 412 which includes portions of the first image 408 and the second image 410. Preferably, the third image 412 is a panoramic image which may comprise portions of two or more source images 408, 410.

Preferably, the data processing module 402 may identify the overlapping region in each of the first and the second sets of image data, i.e. the image portion representing a substantially similar region with similar features on the images. In the overlapping regions, at least one common feature may be identified in the overlapping region of both the first and the second image 410. In general, more common feature being identified is preferable.

In some example embodiment, the source images 408, 410 may include different sizes or portions of overlapping regions. For example, images taken by the CE-3 PCAM may be different from those taken by LROC (Lunar Reconnaissance Orbiter Camera), it may not include a large overlapped area. Thus it may be difficult to accurately find out overlapping regions on the images.

The inventors devise that the problem may be solved as follows. If an image is divided up and down or left and right into 2 slices and each of the slices has twenty precent of overlapped region, feature algorithm may be applied to obtain the features on this two images. At this moment, the feature operators from overlapped regions in these two images are completely equal. By applying a feature matching algorithm to process the feature operators, a pair of matching features in the two overlapped region pair may be obtain.

Preferably, a portion of the data representing a portion of the overlapping region is defined by a divider within the overlapping region and at least one boundary of the overlapping region. The over lapping region may be defined with two boundaries, and a divider is arranged to divide the overlapping region into substantially two halves, i.e. the divider may be defined at or proximate to a center position between the boundaries of the overlapping region, one of the two halves may be discarded or deleted in the image stitching process such that the images may be combined without the identical features being repeatedly included in the panoramic image.

After discarding certain areas in the overlapping region in each of the first and the second images 408, 410, the first and the second sets of image data are transformed to a first and a second sets of modified image data and may be further used to defined the third set of image data arranged to represent a third image 412.

With reference to FIG. 5 and according to an imaging principle, farther from the center of the image or the camera, more changes may be induced to the object/feature captured. Therefore the matching features may not be identical in the overlapped regions boundary. Two divider lines should be obtained. Preferably the divider line may be located at the center of overlapped region.

The shaded areas in FIG. 5 denote two shooting areas. θ₁ is defined as the angle from shooting center 502 to the object 500. When θ₁ equal to θ₂, point in the picture is same. However, in the example illustrated in the Figure, at the θ₁ is not equal to θ₂. So the object 504 may be displayed differently in these two pictures.

By using Least squares method on match features, each of the two images should include a divider line. Since this two overlapped regions should be completely equal, this two divider lines should correspondingly be completely equal.

Subsequently, by discarding the region at left of divider line from right image, and the region at right of divider line from left image, these two slices/portions may be stitched as a single image perfectly, similarly of up and down divide model. However, of the real CE-3 image, two stitching images not divide from an image, the overlapped region is not same. But the camera shooting the same object and the overlapped region of stitching image is similar. The features position would change following the object change at overlapped region. So the line represented by the same objects and environment even the camera changes shooting angle. But using the same method, this two divider lines are not equal neither.

Preferably, the data processing module 402 is further arranged to transform the divider into a linear line using interpolation. Such interpolation process transforms the two divider lines into horizontal line or vertical line to improve the stitching work.

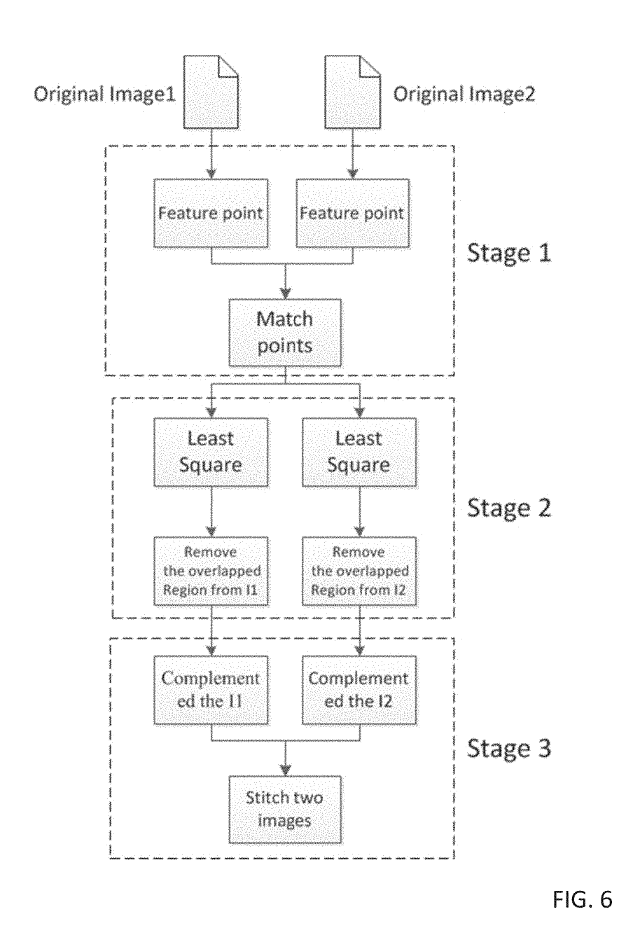

To guarantee that there is no original information loss while stitching images, LLF keeps integrality and continuity of data. With reference to FIG. 6, there is shown an embodiment of a method for creating an image comprising the steps of identifying data representing an overlapping region in each of a first and a second sets of image data, wherein the first and the second sets of image data are arranged to represent a first image 408 and a second image 410 respectively, and at least one common feature in both the first image 408 and the second image 410 is identified in the overlapping region; discarding a portion of the data representing a portion of the overlapping region in each of the first and the second sets of image data to obtain a first and a second sets of modified image data; and combining the first and the second sets of modified image data to a third set of image data arranged to represent a third image 412 including at least a portion of each of the first image 408 and the second image 410.

In this example, the method may be implemented as the

Least-Loss Filling (LLF) method discussed above, and may be carried out by the data processing module 402 and the image processing module 404.

LLF may involve at three major stages as follows:

Stage 1 Feature point matching

Stage 2 Least Square

Stage 3 Complement Image

With reference to FIG. 6, in the first stage, SURF may be applied to find the features. A feature has three useful data: x (abscissa of image), y (ordinate of image) and d (descriptor of feature point). The features vector I1(x(1) i , yi (1), d(1) i) and I2(x(2) i , yi (2), d(2) i) are from two pictures, which has overlapped region. LLF may select the matching features with the least distance screening d(1) i and d(2) i and records the x and y into the match point matrix M.

Preferably, the data processing module 402 is further arranged to discard at least one of the feature points based on at least one selection criteria. The selection criteria may include a position of the feature point beyond a predetermined region in the first and/or the second image 410, such as a predetermined distance between the feature point and a reference location or a predetermined different between the two distance, or the position of the feature point beyond (not within) the overlapping region in the first and/or the second sets of image data.

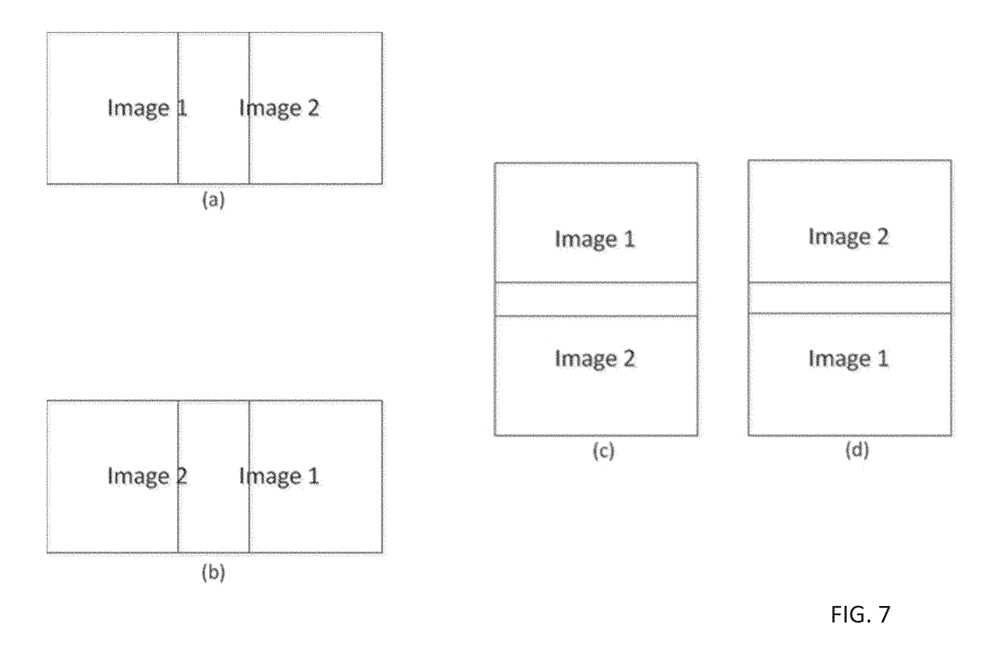

Matching point with large distance or the location of features are not in the overlapped region would be discarded or ignored. LLF may be used to stitch Change' E-3 panoramic image automatically by known the matching points and capture mechanism. Stitching of the two source images may consider 5 directions or arrangements: unable to stitch, above-under, under-above, left-right and right left with reference to FIG. 7.

Preferably, the data processing module 402 is further arranged to perform a regression analysis on the plurality of feature points associated with the at least one common feature to define the divider. For example, the regression analysis may include a least square analysis, which involves the following matrix:

$$M = [ \begin{matrix}{x}_{1}^{( 1 )} & {y}_{1}^{( 1 )} & {x}_{1}^{( 2 )} & {y}_{1}^{( 2 )} \\ {x}_{2}^{( 1 )} & {y}_{2}^{( 1 )} & {x}_{2}^{( 2 )} & {y}_{2}^{( 2 )} \\ ⋮ & ⋮ & ⋮ & ⋮ \\ {x}_{i}^{( 1 )} & {y}_{i}^{( 1 )} & {x}_{i}^{( 2 )} & {y}_{i}^{2}\end{matrix} ] \qquad ( 2 )$$

The matrix M(xᵢ⁽¹⁾,yᵢ⁽¹⁾,xᵢ⁽²⁾,yᵢ⁽²⁾) is divided into M_{I1}(xᵢ⁽¹⁾, yᵢ⁽¹⁾)and M_{I2}(xᵢ⁽²⁾, yᵢ⁽²⁾), compares , xᵢ⁽¹⁾, xᵢ⁽²⁾, and yᵢ⁽¹⁾, yᵢ⁽²⁾ to determine the stitching direction. The length of abscissa in I1 is Lx and the length of ordinate in I₁ is L_{y}. If

$${x}_{i}^{( 1 )} - {x}_{i}^{( 2 )} > \frac{{l}_{x}}{2} ⋁ \vert {y}_{i}^{( 1 )} - {y}_{i}^{( 2 )} \vert < 200 \qquad$$

explained I₁ on the left side of I2;

$${x}_{i}^{( 2 )} - {x}_{i}^{( 1 )} > \frac{{l}_{x}}{2} ⋁ \vert {y}_{i}^{( 1 )} - {y}_{i}^{( 2 )} \vert < 200 \qquad$$

explained I₁ on the right side of I2;

$${x}_{i}^{( 1 )} - {x}_{i}^{( 2 )} > \frac{{l}_{y}}{2} ⋁ \vert {x}_{i}^{( 1 )} - {x}_{i}^{( 2 )} \vert < 300 \qquad$$

explained I₁ above I₂;

$${y}_{i}^{( 2 )} - {y}_{i}^{( 1 )} > \frac{{l}_{y}}{2} ⋁ \vert {x}_{i}^{( 2 )} - {x}_{i}^{( 1 )} \vert < 300 \qquad$$

explained I₁ under I₂; Otherwise these two images don't have overlapped region. The data processing module 402 may compare the first and the second sets of image data so as to determine the plurality of feature points based on the abovementioned relation.

By using Least Square to processing M_{I1}(xᵢ⁽¹⁾, yᵢ⁽¹⁾) and M_{I2}(xᵢ⁽²⁾, yᵢ⁽²⁾), the dividing line 11 (x, y), 12 (x, y) of useful area and useless area may be determined. The dividing line may be represented according to the following relation:

$$\begin{matrix}l ( x , y ) ≡ y = {a}_{2} {x}^{2} + {a}_{1} x + {a}_{0} & ( 3 ) \\ \frac{\partial φ}{\partial {a}_{0}} = - 2 \sum ( {y}_{i} - {a}_{0} - {a}_{1} {x}_{i} - {a}_{2} {x}_{i}^{2} ) = 0 \\ \frac{\partial φ}{\partial {a}_{1}} = - 2 {x}_{i} \sum ( {y}_{i} - {a}_{0} - {a}_{1} {x}_{i} - {a}_{2} {x}_{i}^{2} ) = 0 \\ \frac{\partial φ}{\partial {a}_{2}} = - 2 {x}_{i}^{2} \sum ( {y}_{i} - {a}_{0} - {a}_{1} {x}_{i} - {a}_{2} {x}_{i}^{2} ) = 0 & ( 4 )\end{matrix}$$

20

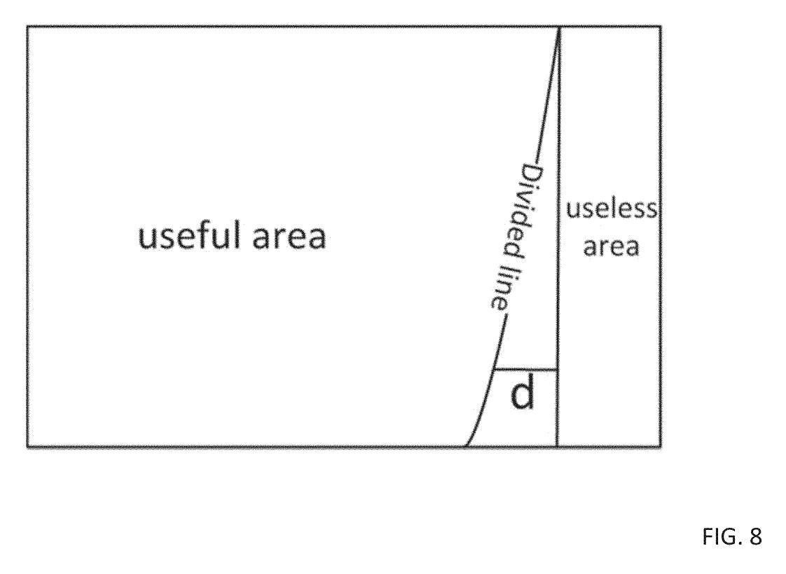

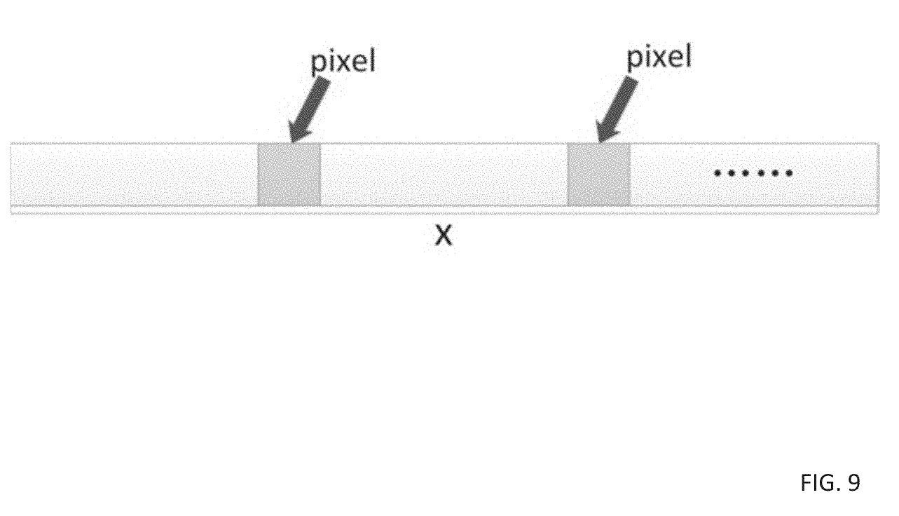

With reference to FIGS. 8 and 9, image I1 and I2 should follow horizontal model, similarly for 1(y, x) the images should follow vertical mode. The overlapped region of stitching images may be discarded according to divided line. In some examples, the divided line is not a linear line, therefore the method include a final step to complement useful area to become a rectangle.

For example, in case of horizontal model, let maximum of x be the boundary of image width. If xᵢ is less than xₘₐₓ, it will insert dᵢ pixels in that row, to ensure that xᵢ of each row is equal to xₘₐₓ according to the following relation:

$${x}_{ma x} = maximum ( l ( x , y ) , x ) \\ {d}_{i} = {x}_{ma x} - {x}_{i} \\ δ = \frac{{x}_{i}}{{d}_{i}} \qquad ( 5 )$$

After complementing two images, the right stitch position is depending on δy. δy is malposition of two stitching image and defines as

δ_{y}=mean (i₁(x,y),y)−mean(i₂(x,y),y) (6)

These embodiments may be advantageous in that the device for generating an image may be used to stitch multiple images to form a continuous panoramic image with minimal error induced in the final panoramic image. The method involve a regression analysis of the features points in the overlapping regions may allow the determination of a best possible divider line for combining the two source images at the best possible position and alignment.

The inventors also carried out experiments in accordance with several embodiments of the present invention. In the experiment, the image data is obtained based on actual panoramic image data return by Change' E-3 rover. The experiments involve many different images in different shooting environment and different direction, including images with many stones, lunar dust, crater, clutter, shadow, sky (black area) and different illumination.

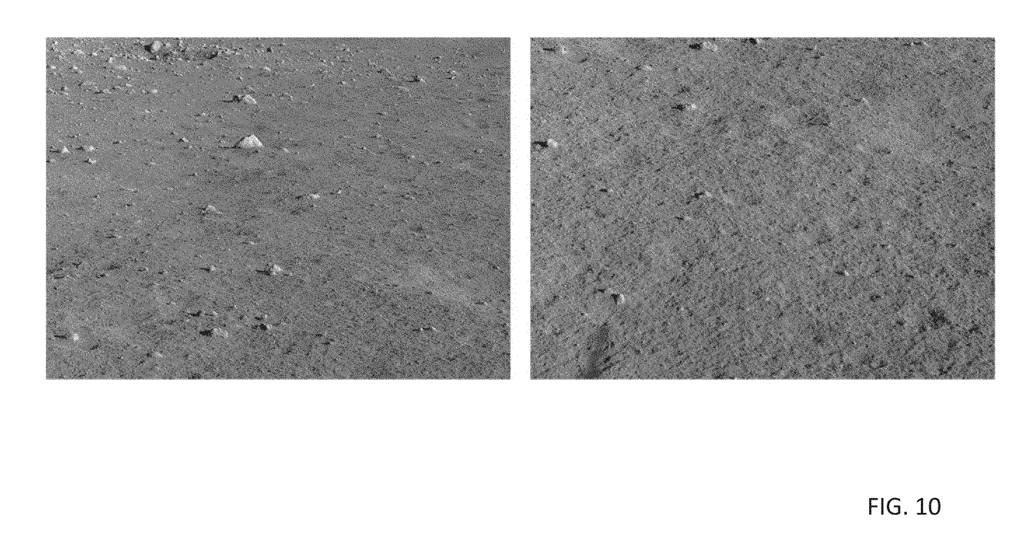

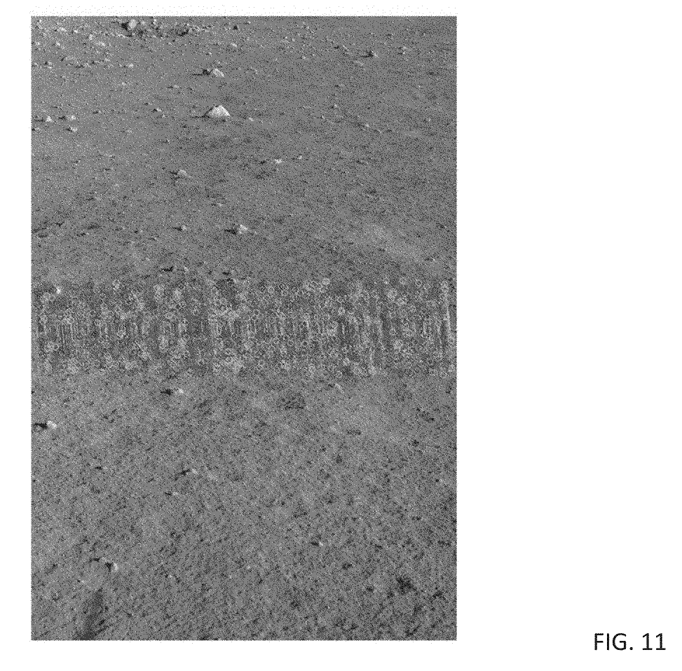

As described, Change' E-3 panoramic image may include five different stitching cases and the experiments include different stitching situations of direction. With reference to FIG. 10, there is shown two original panoramic images. Since the characteristic of two images is not obvious, it may be difficult to find the stitching direction by observation. Referring to FIG. 11, the matching points are located on the two images. Subsequently, by analyzing matching point by created method, the stitching direction has been confirmed.

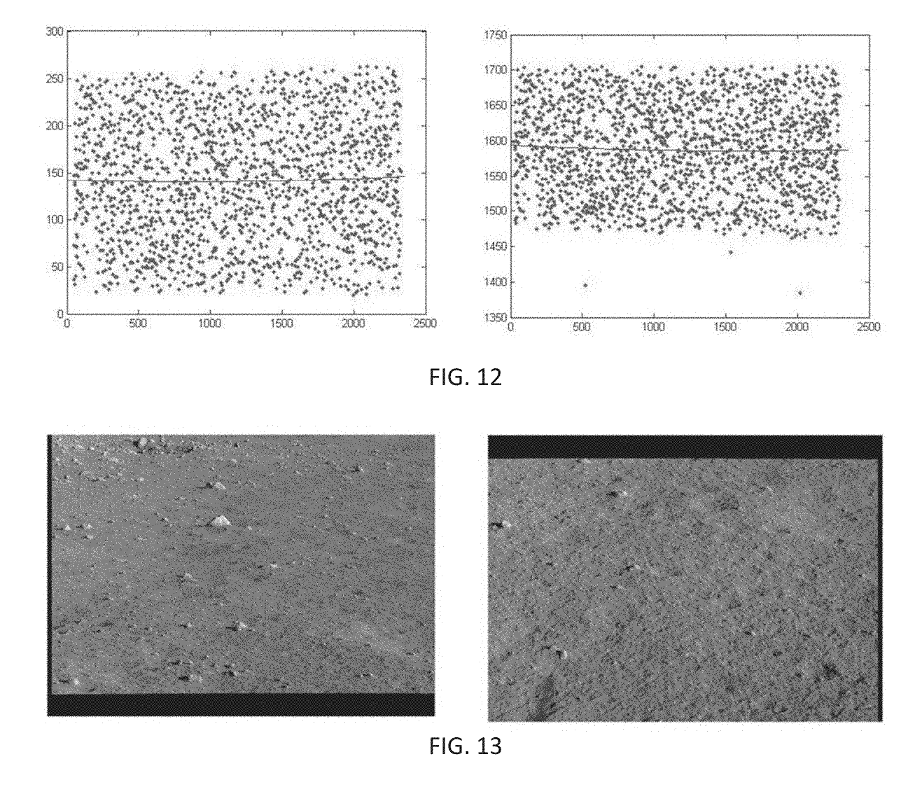

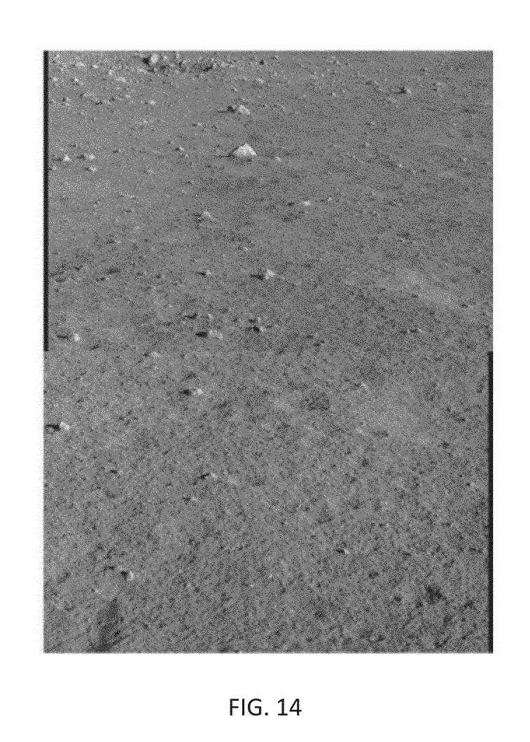

With reference to FIG. 12, the divider line is determined using least square. After deleting/discarding the overlapped according divided line, the images with black area, the black area is the overlapped that is deleted as showning in FIG. 13. Following the completion method described, there are two transformed images which need to arrange them in right direction and position. Finally a third image 412/a panoramic image is shown with reference to FIG. 14. Through observing the stones in the final panoramic image, the stitching effect may be evaluated.

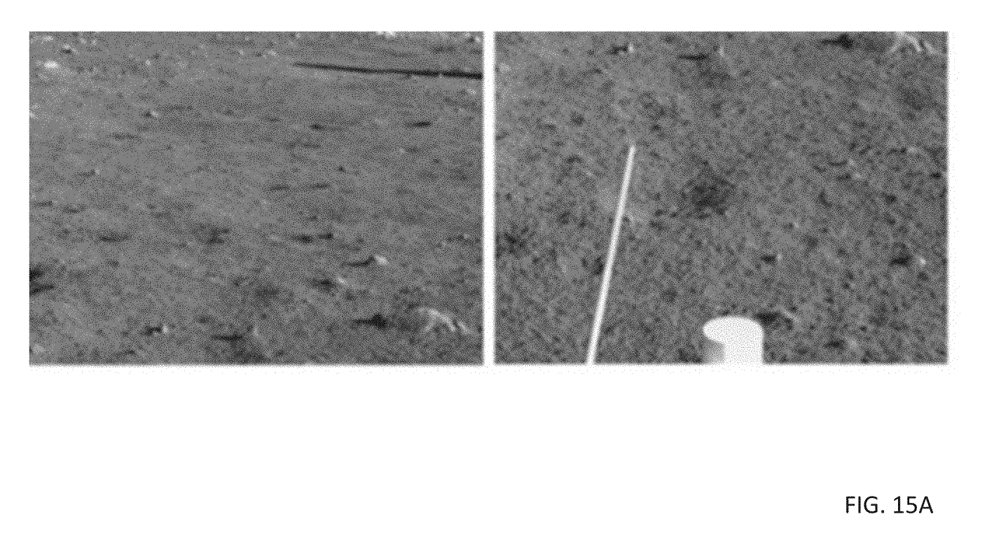

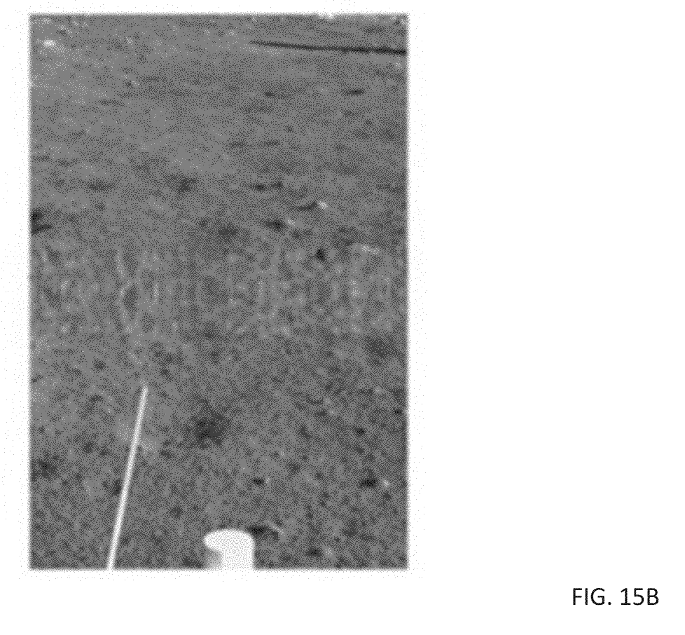

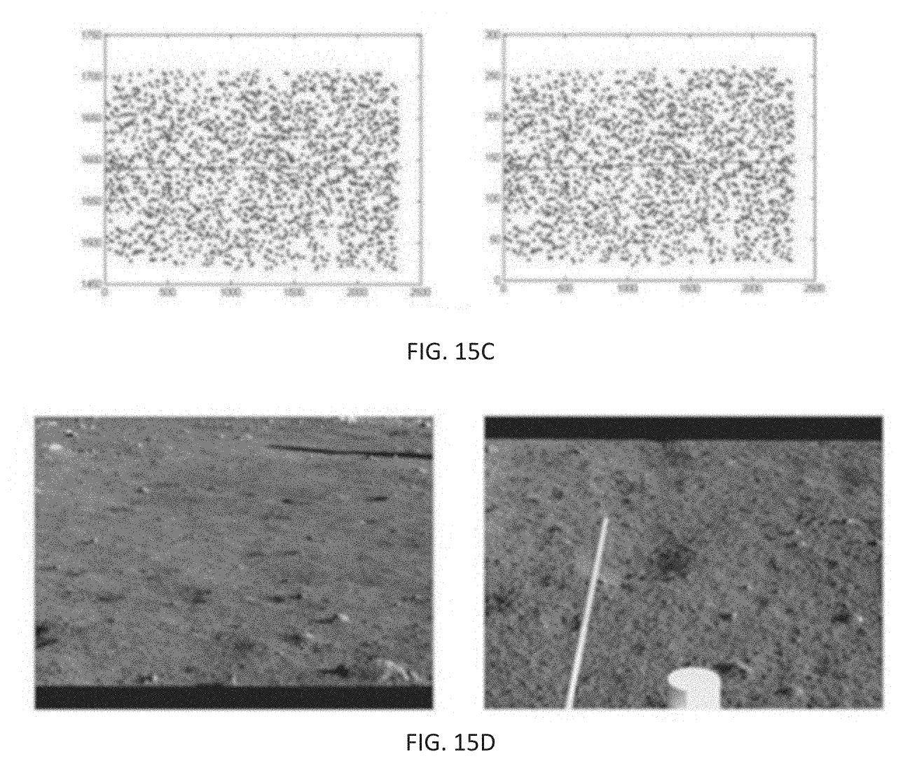

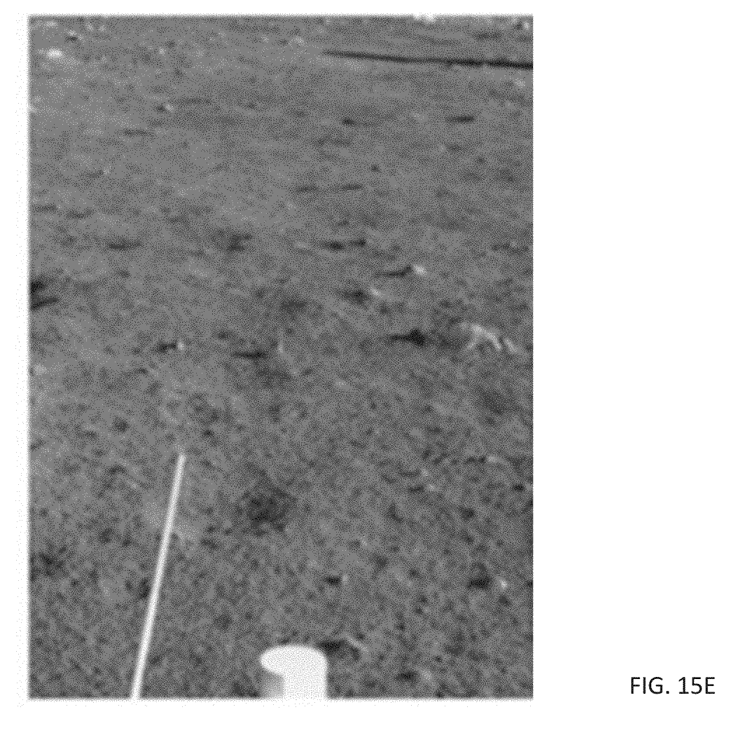

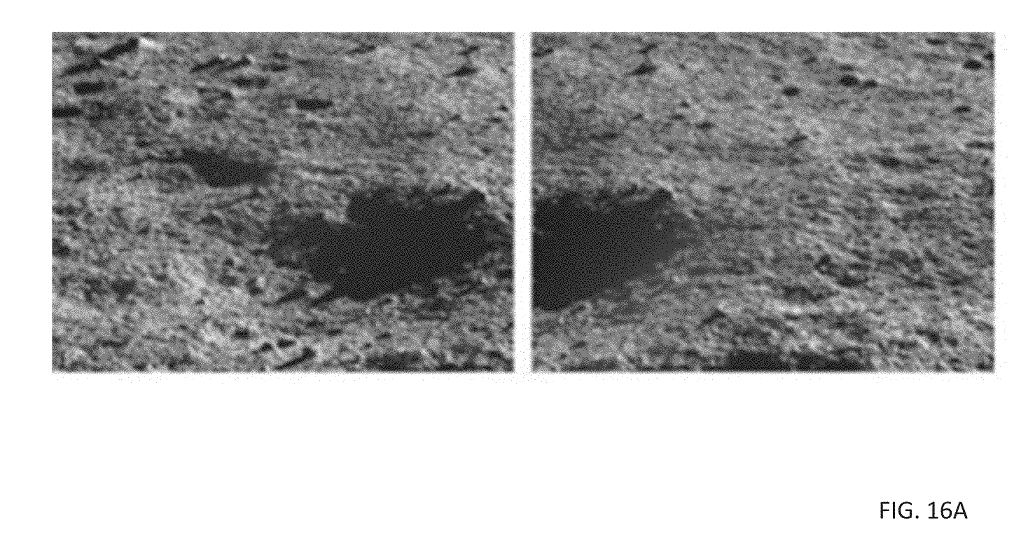

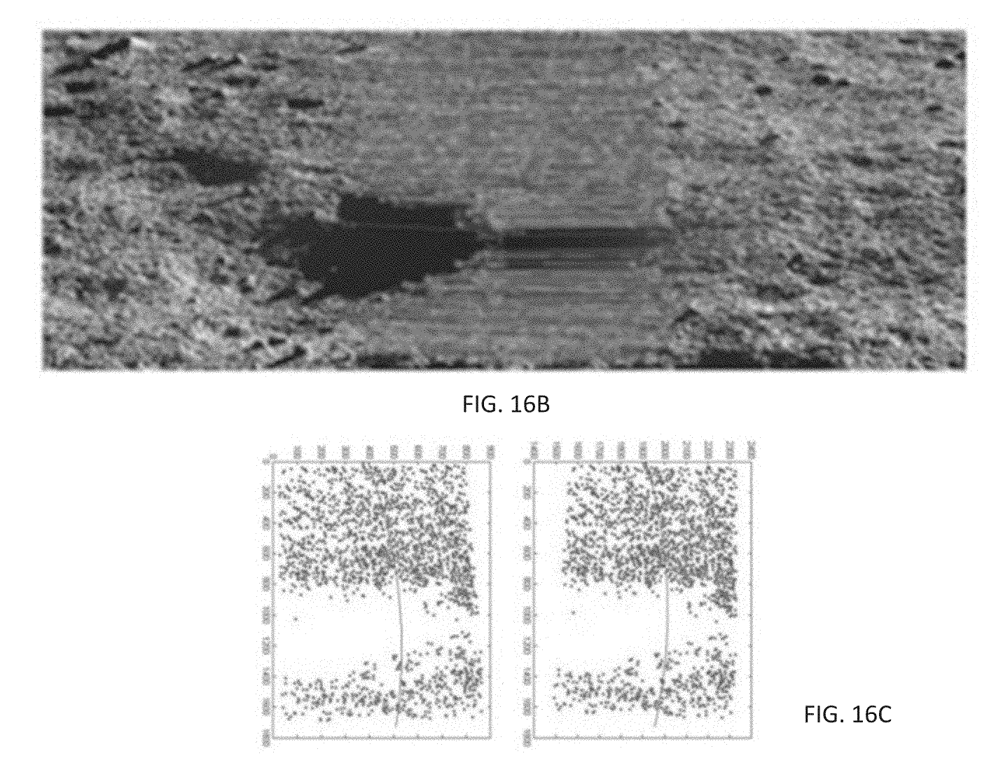

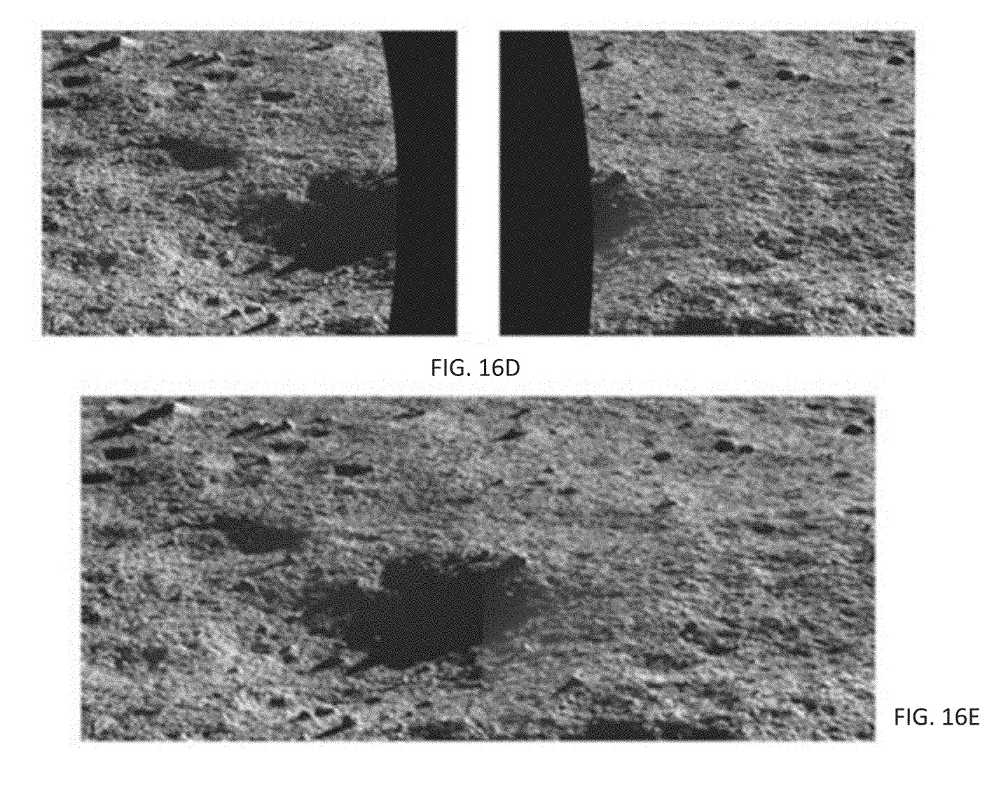

With reference to FIGS. 15A-15E and 16A-16E, there is shown two other examples of the stitching process similar to FIGS. 10-14. The images are of different illumination, stone and crater. The results show that the method in accordance with the present invention is suitable for different stitching conditions.

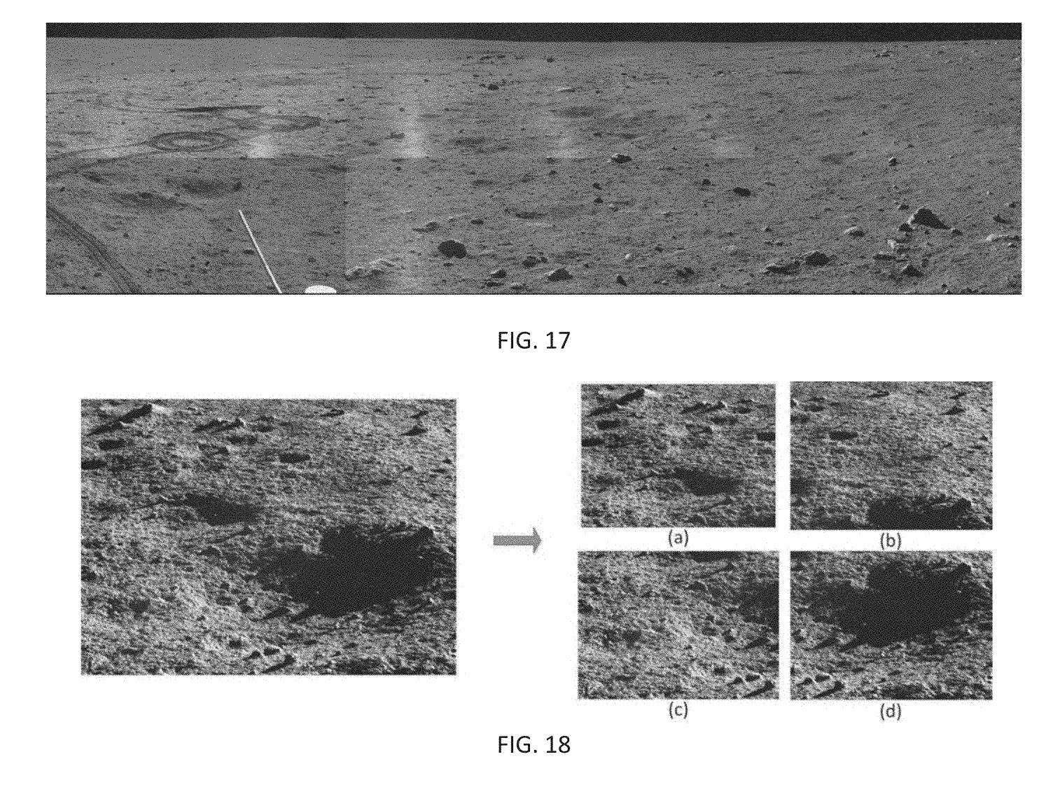

With reference to FIG. 17, there is shown a portion of a whole lunar surface panoramic image. For the sake of quantization the result for algorithm, the experiment samples including the known stitching position may be obtained.

With reference to FIG. 18, a Change' E-3 panoramic image is divided into 4 pieces with overlapped region. The stitching process may be performed along the vertical and horizontal direction. The final work are the evaluate the stitching result with the size, comparing the divide lines of two images and getting the abstract deviation d average deviation d0̅as shown in Table 4 according to the following relation. It is shown that the percentage change and the deviation between the original image and the processed image is insignificant.

$$\begin{matrix}d = \sqrt{\sum ( {d}_{i}^{1} - {d}_{i}^{2} )} & ( 7 ) \\ \overline{d} = \frac{d}{length ( stitchingside )} & ( 8 )\end{matrix}$$

TABLE IV
COMPARE SIFT WITH SURF

| Images | original size | size of result | change percentage | deviation abstract | deviation | average deviation |
|---|---|---|---|---|---|---|
| a, c | 1376 × 1728 | 1376 × 1762 | 1.93% | 2.89E−10 | 199 | 0.145 |
| b, d | 1377 × 1728 | 1377 × 1822 | 5.16% | −6.34E−10 | 248 | 0.180 |
| a, b | 2352 × 1014 | 2370 × 1014 | 0.76% | 5.23E−10 | 204 | 0.201 |
| c, d | 2352 × 1015 | 2380 × 1015 | 1.18% | 6.99E−10 | 149 | 0.147 |

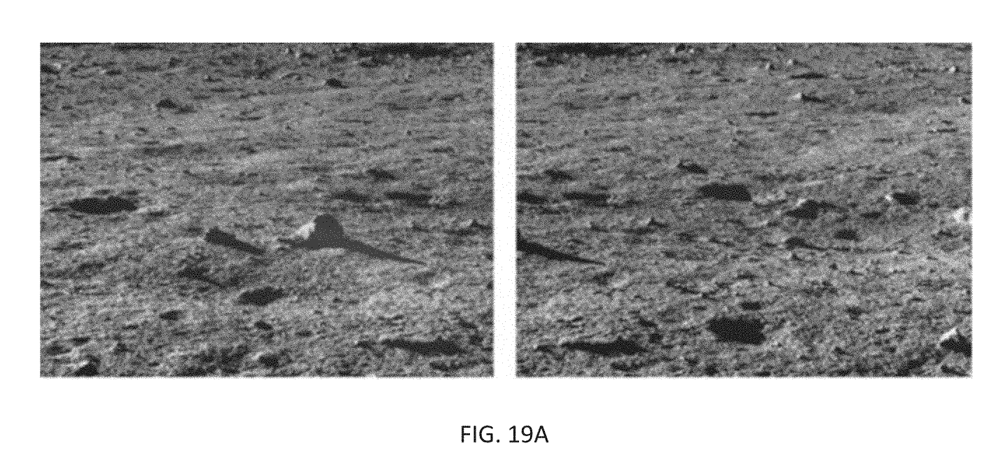

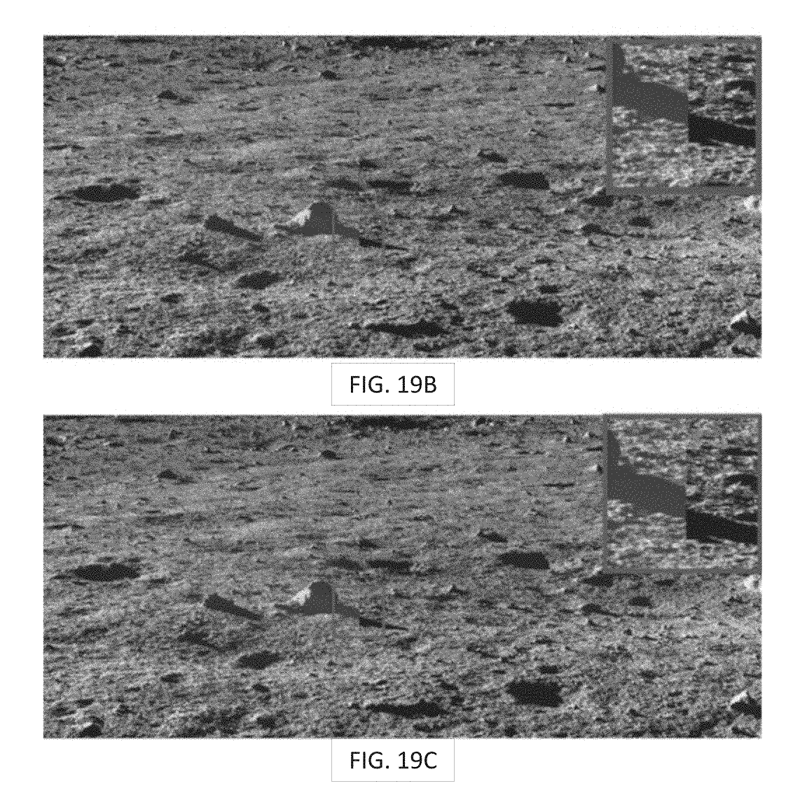

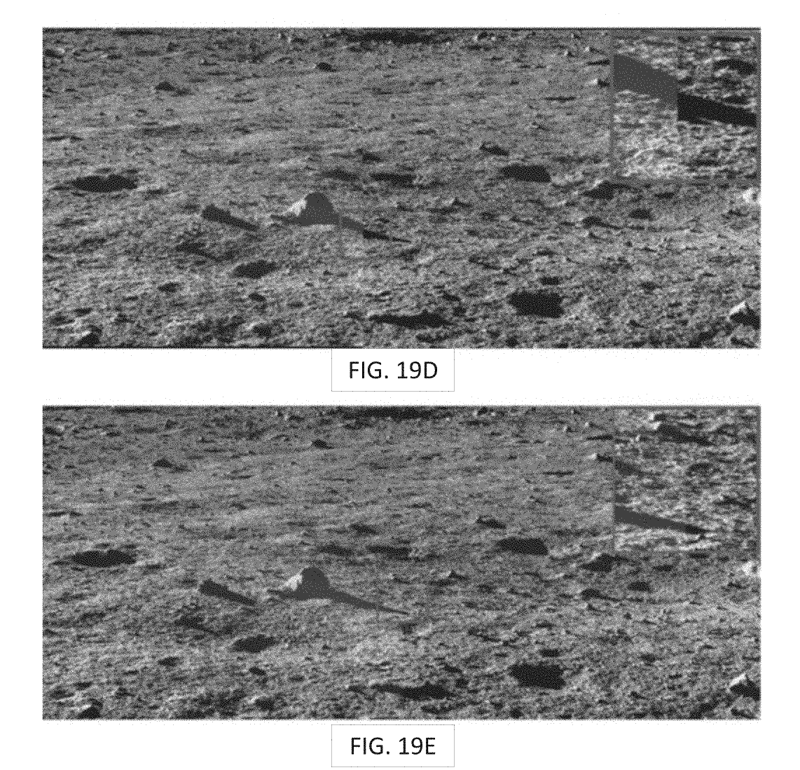

The method in accordance with the present invention, such as LLF, is also compared with other stitching methods such as linear least square method, B-spline least square method and many knot splines least square method. With reference to FIGS. 19-21, it is observed that the LLF provides a best effect as shown in FIG. 19E, 20E and 21E.

With reference to FIGS. 19A to 19E, the areas marked displacement in rectangle and enlarged the region in window at a corner of the images. As shown in FIG. 19E, the shadow obtained from after the stitching process is smooth, which is different from the broken or misaligned pattern in FIGS. 19B, 19C and 19D.

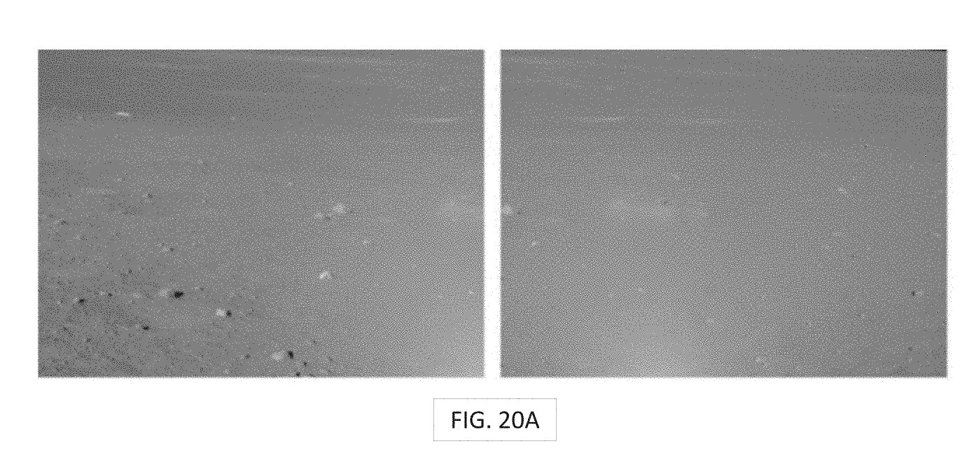

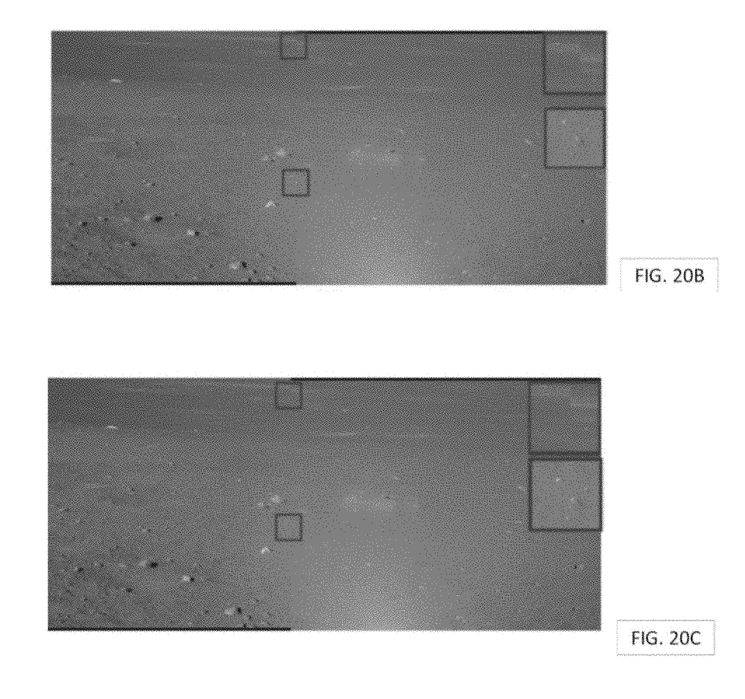

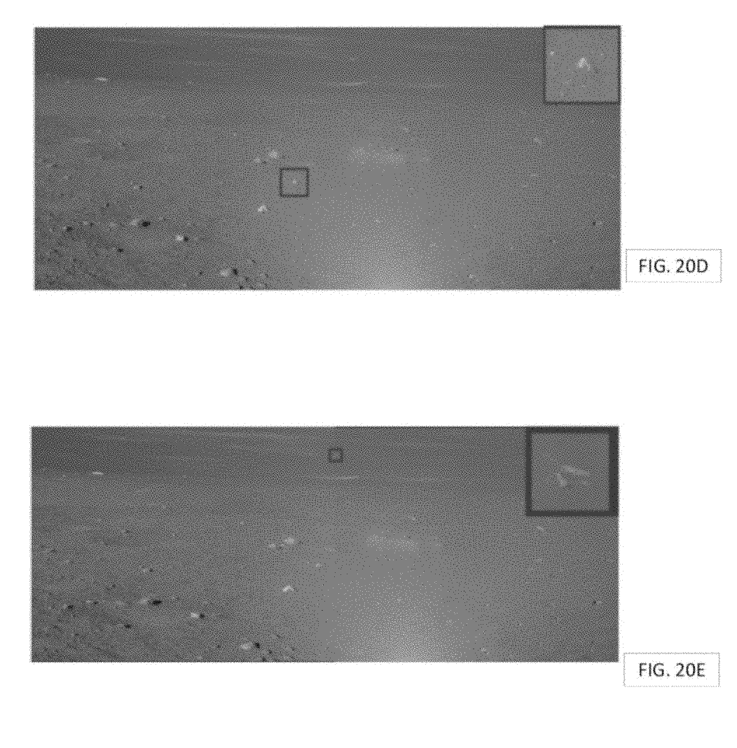

With reference to FIGS. 20B and 20C, there exist obvious errors in displacement and a half of stone which marked in the rectangle is disappeared. And a small error of displacement on the stone is shown in FIG. 20D. In contrast, although LLF induce an error as shown, the error is relatively minor when compared with the original images and the other results.

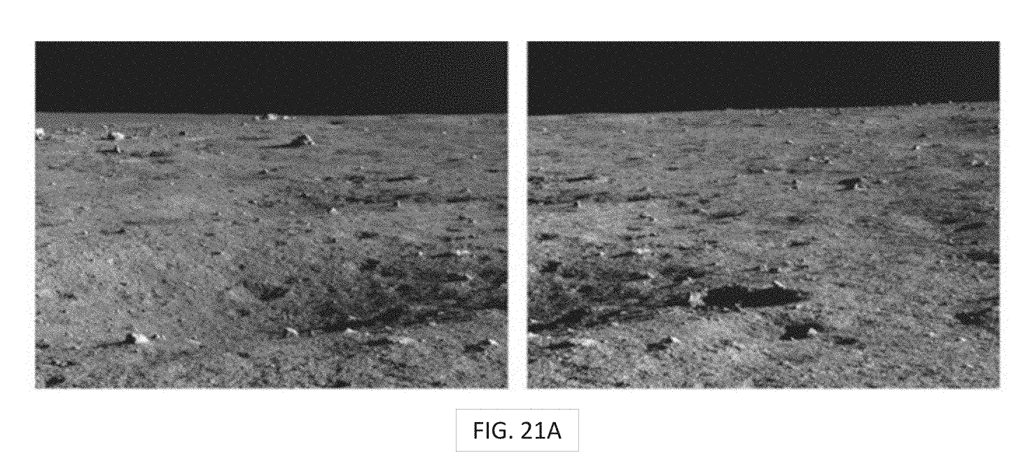

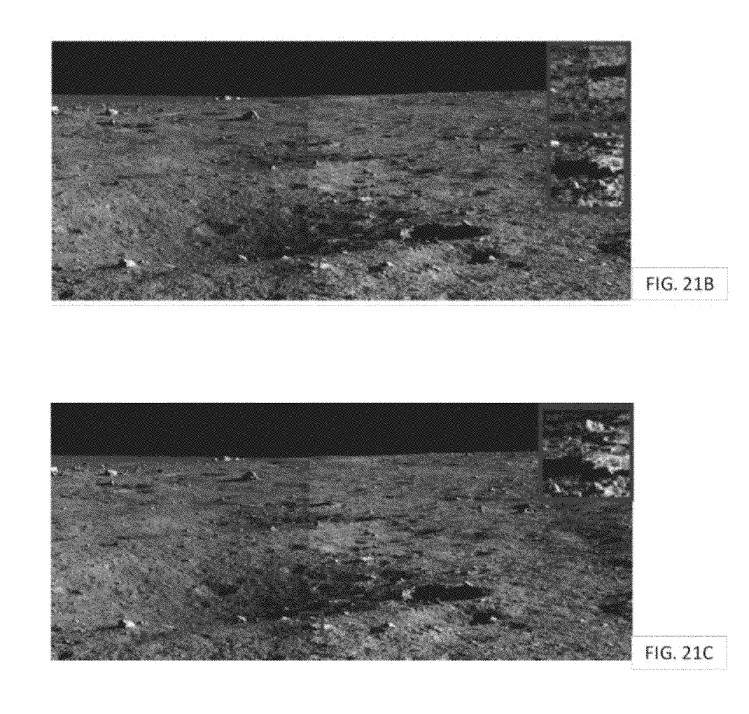

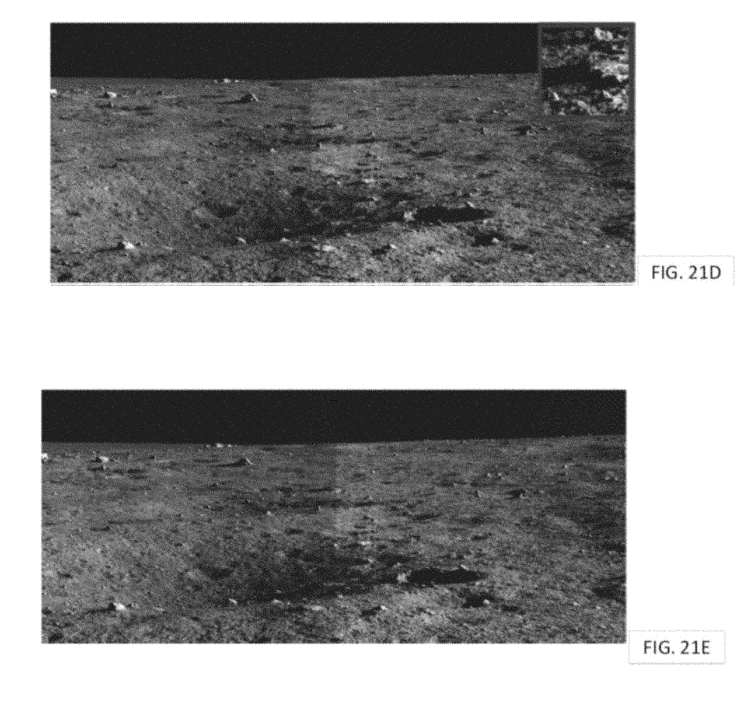

With reference to FIGS. 21B to 21E, after enlarging the of result stitched images, errors are observed in FIGS. 21B to 21D. The result of stitching image from LLF in accordance with the embodiments of the present invention does not introduce any obvious error observable by naked eye.

It will also be appreciated that where the methods and systems of the present invention may be either wholly implemented by computing system or partly implemented by computing systems then any appropriate computing system architecture may be utilised. This will include stand alone computers, network computers and dedicated hardware devices. Where the terms “computing system” and “computing device” are used, these terms are intended to cover any appropriate arrangement of computer hardware capable of implementing the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. A method for creating an image, comprising the steps of:
identifying data representing an overlapping region in each of a first and a second sets of image data, wherein the first and the second sets of image data are arranged to represent a first image and a second image respectively, and at least one common feature in both the first image and the second image is identified in the overlapping region;
discarding a portion of the data representing a portion of the overlapping region in each of the first and the second sets of image data to obtain a first and a second sets of modified image data; and
combining the first and the second sets of modified image data to a third set of image data arranged to represent a third image including at least a portion of each of the first image and the second image.

2. A method for creating an image in accordance with claim 1, wherein a portion of the data representing a portion of the overlapping region is defined by a divider within the overlapping region and at least one boundary of the overlapping region.

3. A method for creating an image in accordance with claim 2, wherein the divider is defined at or proximate to a center position between the boundaries of the overlapping region.

4. A method for creating an image in accordance with claim 2, further comprising the step of transforming the divider into a linear line using interpolation.

5. A method for creating an image in accordance with claim 2, further comprising the step of performing a regression analysis on a plurality of feature points associated with the at least one common feature to define the divider.

6. A method for creating an image in accordance with claim 5, wherein the regression analysis include a least square analysis.

7. A method for creating an image in accordance with claim 5, further comprising the step of comparing the first and the second sets of image data so as to determine the plurality of feature points.

8. A method for creating an image in accordance with claim 7, further comprising the step of discarding at least one of the plurality of feature points based on at least one selection criteria.

9. A method for creating an image in accordance with claim 8, wherein the at least one selection criteria includes at least one of:
a position of the feature point beyond a predetermined region in the first and/or the second image; and
a position of the feature point beyond the overlapping region in the first and/or the second sets of image data.

10. A method for creating an image in accordance with claim 1, wherein the third image is a panoramic image.

11. A device for creating an image, comprising:
a data processing module arranged to identify data representing an overlapping region in each of a first and a second sets of image data, wherein the first and the second sets of image data are arranged to represent a first image and a second image respectively, and at least one common feature in both the first image and the second image is identified in the overlapping region; and
an image processing module arranged to discard a portion of the data representing a portion of the overlapping region in each of the first and the second sets of image data to obtain a first and a second sets of modified image data, and arranged to combine the first and the second sets of modified image data to a third set of image data arranged to represent a third image including at least a portion of each of the first image and the second image.

12. A device for creating an image in accordance with claim 11, wherein a portion of the data representing a portion of the overlapping region is defined by a divider within the overlapping region and at least one boundary of the overlapping region.

13. A device for creating an image in accordance with claim 12, wherein the divider is defined at or proximate to a center position between the boundaries of the overlapping region.

14. A device for creating an image in accordance with claim 12, wherein the data processing module is further arranged to transform the divider into a linear line using interpolation.

15. A device for creating an image in accordance with claim 12, wherein the data processing module is further arranged to perform a regression analysis on a plurality of feature points associated with the at least one common feature to define the divider.

16. A device for creating an image in accordance with claim 15, wherein the regression analysis include a least square analysis.

17. A device for creating an image in accordance with claim 15, wherein the data processing module is further arranged to compare the first and the second sets of image data so as to determine the plurality of feature points.

18. A device for creating an image in accordance with claim 17, wherein the data processing module is further arranged to discard at least one of the plurality of feature points based on at least one selection criteria.

19. A device for creating an image in accordance with claim 18, wherein the at least one selection criteria includes at least one of:
a position of the feature point beyond a predetermined region in the first and/or the second image; and
a position of the feature point beyond the overlapping region in the first and/or the second sets of image data.

20. A device for creating an image in accordance with claim 11, wherein the third image is a panoramic image.
